(19) United States
(12) Patent Application Publication
(10) Pub. No.: US 2015/0244598 A1
(43) Pub. Date: Aug. 27, 2015

(54) REMOTE MONITORING OF EVENTS ON A NETWORK USING LOCALIZED SENSORS

(71) Applicant: Endgame Systems, Inc., Atlanta, GA (US)

(72) Inventors: Nils D. Puhlmann, Pleasant Hill, CA (US); John Herren, Atlanta, GA (US); Earle W. Ady, San Francisco, CA (US); Michael Kelly Whalen, Great Falls, VA (US); Justin Trent Altman, Washington, DC (US); David M. Nichols, Washington, DC (US); Robert Geoffrey Meyers, Smyrna, GA (US); Anderson Osagie, Fort Washington, MD (US); Sudhanshu Sethi, Cupertino, CA (US)

(73) Assignee: Endgame Systems, Inc., Atlanta, GA (US)

(21) Appl. No.: 14/187,012

(22) Filed: Feb. 21, 2014

(51) Int. Cl. H04L 12/26; H04L 12/24

(52) U.S. Cl. CPC H04L 43/0823; H04L 43/08; H04L 41/0869

(57) ABSTRACT

A remote sensing system comprising localized sensors and monitoring by one or more servers is described. The sensors capture data from computers and the network, provide that information to the one or more servers, and the one or more servers identify trends and anomalies in the information collected. The one or more servers provide information regarding the trends and anomalies to the computers. Optionally, the one or more servers can push changes to the sensors, such as updates to software code.

A remote sensing system comprising localized sensors and monitoring by one or more servers is described. The sensors capture data from computers and the network, provide that information to the one or more servers, and the one or more servers identify trends and anomalies in the information collected. The one or more servers provide information regarding the trends and anomalies to the computers. Optionally, the one or more servers can push changes to the sensors, such as updates to software code.

### TECHNICAL FIELD

A remote sensing system comprising localized sensors and monitoring by one or more servers is described.

### BACKGROUND OF THE INVENTION

Remote sensing of events on a network is known in the prior art. Prior art systems, however, are limited in the ability to identify trends and anomalies in the data collected by the sensors. Prior art systems also do not have the ability to update the sensors remotely to cause them to capture a new type of data or to take action differently based on the trends and anomalies data being pushed to them. Prior art systems also do not have the ability to identify trends and anomalies using data collected from multiple sites or customers.

What is needed is an improved remote sensing system that is able to identify trends and anomalies in data collected from a plurality of sensors across sites or customers and provide threat intelligence based on vertical segments of an industry as well as based on industry sectors.

### SUMMARY OF THE INVENTION

The aforementioned problem and needs are addressed through an improved remote sensing system.

### BRIEF DESCRIPTION OF THE DRAWINGS

FIG. 1 depicts an embodiment of a remote monitoring system.

FIG. 2 depicts another embodiment of a remote monitoring system.

### DETAILED DESCRIPTION OF THE PREFERRED EMBODIMENTS

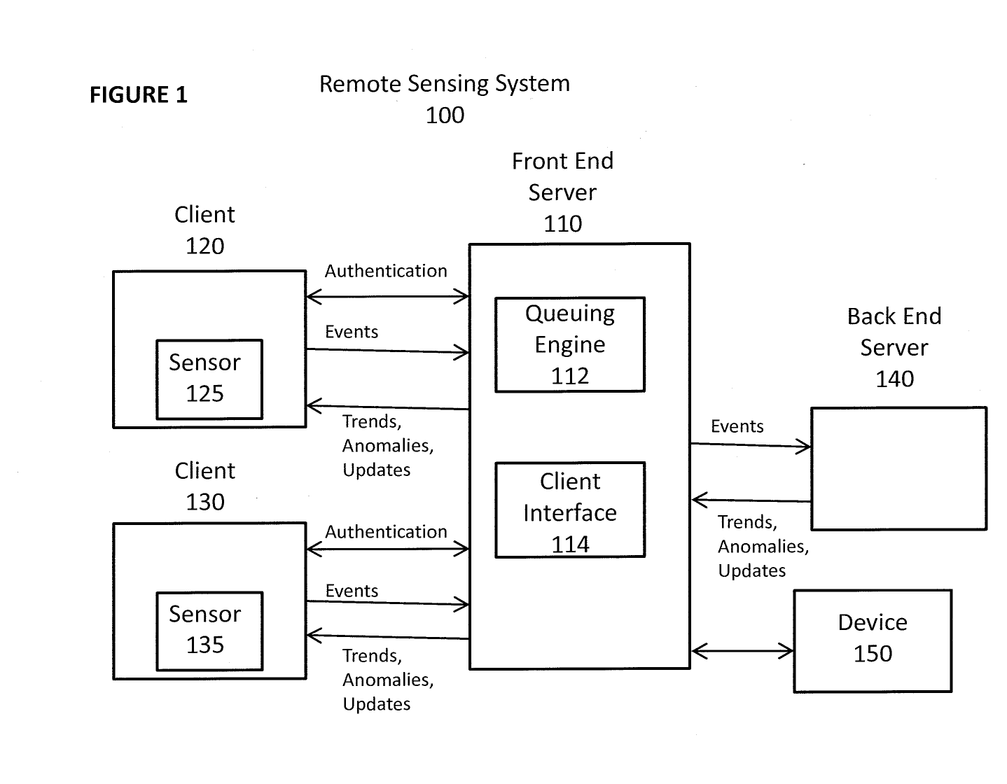

An embodiment will now be described with reference to FIG. 1. Remote sensing system 100 is depicted and comprises representative client 120 and client 130, front end server 110, back end server 140, and device 150. Other clients of similar structure to client 120 and client 130 can also be used, but for illustration purposes, only two clients are shown. Client 120, client 130, front end server 110, back end server 140, and device 150 each are computing devices comprising at least one processor, memory, non-volatile storage (such as a hard disk drive or flash memory array), and a network interface. The network interface can be a wired interface (such as Ethernet), a wireless interface (such as WiFi), or both. Client 120, client 130, front end server 110, back end server 140, and device 150 communicate over a network, such as the Internet, a LAN, or other type of network.

Client 120 comprises sensor 125 and client 130 comprises sensor 135. Sensor 125 and sensor 135 are software code running on client 120 and client 130, respectively, and are described in greater detail below.

Front end server 110 comprises queuing engine 112 and client interface 114. Queuing engine 112 is software code that performs a queuing function for data received from client 120 and client 130 and data received from back end server 140. Client interface 114 is software code that interacts with client 120 and client 130.

Client interface 114 also can interact with device 150, which is intended to be a recipient of trends data and anomalies data generated by back end server 140, described below. In contrast to client 120 and client 130, device 150 does not contain a sensor.

Sensor 125 and sensor 135 are designed to collect information from client 120 and client 130, respectively, and to provide that information to client interface 114 in front end server 110. This capability can be useful for security purposes. Examples of the type of information that sensor 125 and sensor 135 can collect include memory usage of the client (client 120 or client 130), CPU usage, disk usage, if the role has changed from being a database server to a web server, high packet error rate for network communication, a high failed login rate, raw socket usage, whether a crontab file has been modified, whether an SSH key file has been modified, and whether configuration files have been modified.

In operation, client 120 and client 130 first are authenticated by front end server 110 and back end server 140. Back end server 140 generates a token comprising an API key and a secret key known to the sensor that is sent to the sensor (sensor 125 or sensor 135). Thereafter, sensor 125 and sensor 135 collect information as described above and communicate that information, along with a UUID (unique identifier), to front end server 110 via client interface 114. Queuing engine 112 places the received information into a queue and later provides the information to back end server 140. Optionally, the information can be exchanged from client 120 and client 130 to front end server 110 and back end server 140 using hash-based message authentication codes (HMACs). Messages to the sensors are authenticated using an X.509 Certificate.

Back end server 140 performs analysis on the information received from front end server 110. For example, back end server 140 is configured to identify trends and anomalies in the information. An example of a trend is the behavior of a particular user—how often he or she logs on to a computer (such as client 120 or client 130), where they log in from, how long they stay on the network, how long they stay on a VPN, etc. Trends can be identified for entities (users, devices, services) and on data captured over a predetermined amount of time, such as one month, six months, etc.

Once back end server 140 has identified trends, it also will be able to identify anomalies, which are deviations from trends. For example, if a user logs on from two different locations at the same time or logs in from a location that is physically distant from the places where he or she normally logs in from, that behavior can be flagged as an anomaly. Anomalies might indicate a breach in security of a client or network.

Trends are also determined based on multiple sites or customers. For example, trends can be determined based on data collected from multiple different sets of sensors used in multiple networks. Back end server 140 can determine the types of customers, the types of servers (i.e., the roles of the server such as web server), and what their typical actions are across the network for a specific or multiple vertical segments of an industry and/or across the network for a specific or multiple industries.

Back end server 140 can provide information regarding trends and anomalies to front end server 110, which will place that information into queues using queuing engine 112. Optionally, a separate queue can be created for trends and anomalies for each client, such as client 120 and client 130. Front end server 110 then can provide the trends data and anomalies data to one or more of clients 120 and clients 130, and/or to device 150. Front end server 110 optionally can provide recommended actions at the same time. For example, “Potential Security Breach on Client 120—Check for Virus.”

Back-end server 140 exhibits machine learning. If back-end server 140 identifies an anomaly but a client later informs front end server 110 that there was no actual anomaly but rather that it was expected behavior, back end server 140 will make a note of this feedback and update its trending model and anomaly detection engine accordingly.

In another aspect of the embodiments, back end server 140 and/or front end server 110 can push changes to sensor 125 and sensor 135. For example, they can push changes in software code that will enable sensor 125 and sensor 135 to collect new types of information. They also can push information to client 120 and client 130 regarding how to interpret trends and anomalies data to minimize the occurrence of false positives.

In one embodiment, front end server 110 and back end server 140 are located in the cloud and are accessed by client 120 and client 130 over the Internet or another network. In another embodiment, front end server 110 is located in the same network as client 120 and client 130 (e.g., at a customer site) and back end server 140 is still located in the cloud and accessed over the Internet or another network.

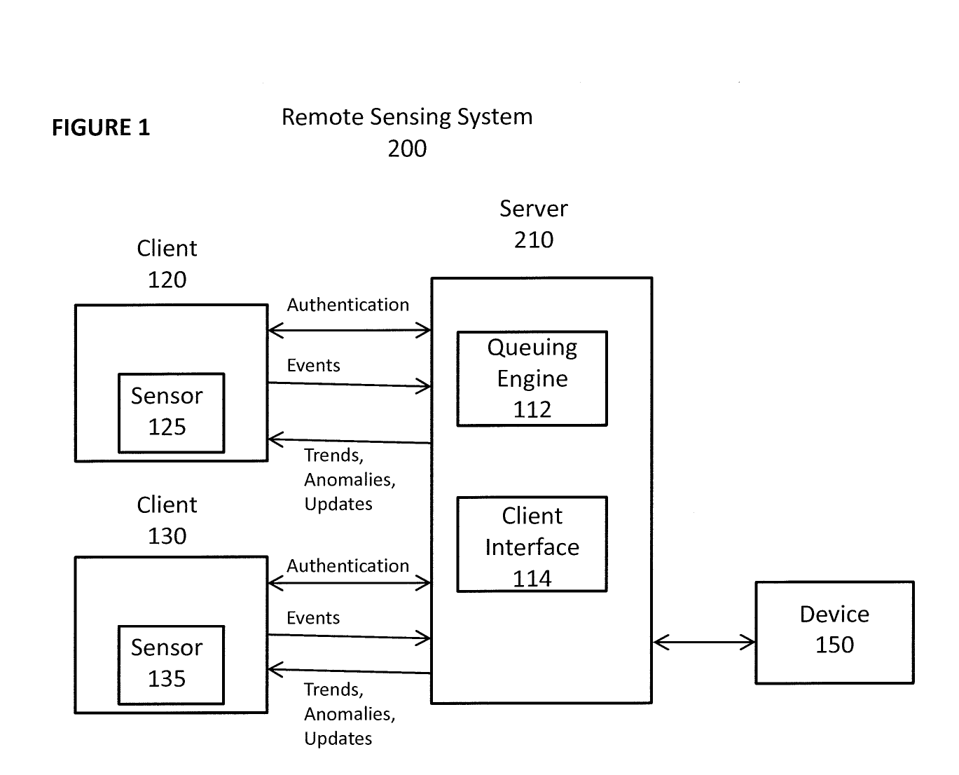

With reference to FIG. 2, another embodiment is shown. Remote sensing system 200 comprises, client 120, client 130, and device 150. However, the functions of front end server 110 and back end server 140 have now been combined into one server, server 210. Remote sensing system 200 otherwise operates the same as remote sensing system 100 described with reference to FIG. 1.

References to the present invention herein are not intended to limit the scope of any claim or claim term, but instead merely make reference to one or more features that may be covered by one or more of the claims. Structures, processes and numerical examples described above are exemplary only, and should not be deemed to limit the claims.

What is claimed is:

1. A system for remote sensing, comprising:
a plurality of client computers, each client computer comprising a sensor for collecting information;
a first server comprising a client interface for communicating with the plurality of client computers and a queuing engine for receiving the information collected by the sensors and storing the information in a queue; and
a second server for analyzing the information collected by the sensors and for generating trends data and anomalies data and for providing the trends data and anomalies data to one or more of the plurality of client computers;
wherein the sensors can be updated remotely by the first server or second server.

2. The system of claim 1, wherein the queuing engine is configured to store in a second queue trends data and anomalies data received from the second server.

3. The system of claim 1, wherein at least some of the trends data is based on information collected by the sensors over a predetermined time period.

4. The system of claim 3, wherein the predetermined time period is one month.

5. The system of claim 1, wherein the information collected by the sensors comprises information indicating a high packet error rate for network communication.

6. The system of claim 1, wherein the information collected by the sensors comprises information indicating a high failed login rate.

7. The system of claim 1, wherein the information collected by the sensors comprises information indicating that a crontab file has been modified.

8. The system of claim 1, wherein the information collected by the sensors comprises information indicating that an SSH key file has been modified.

9. The system of claim 1, wherein the information collected by the sensors comprises information indicating that a configuration file has been modified.

10. The system of claim 1, wherein the first server and second server are located in the cloud.

11. A method for remote sensing, comprising:
collecting information from a plurality of client computers using a sensor located on each client computer;
receiving, by a first server, the information collected by the sensors and storing the information in a queue maintained by a queuing engine;
analyzing, by a second server, the information collected by the sensors;
generating, by the second server, trends data and anomalies data based on the analyzing step;
providing the trends data and anomalies data to one or more of the plurality of client computers; and
updating the sensors remotely by the first server or second server;

12. The method of claim 11, further comprising storing, by the queuing engine, trends data and anomalies data received from the second server in a second queue.

13. The method of claim 11, wherein at least some of the trends data is based on information collected by the sensors over a predetermined time period.

14. The method of claim 13, wherein the predetermined time period is one month.

15. The method of claim 11, wherein the information collected by the sensors comprises information indicating a high packet error rate for network communication.

16. The method of claim 11, wherein the information collected by the sensors comprises information indicating a high failed login rate.

17. The method of claim 11, wherein the information collected by the sensors comprises information indicating that a crontab file has been modified.

18. The method of claim 11, wherein the information collected by the sensors comprises information indicating that an SSH key file has been modified.

19. The method of claim 11, wherein the information collected by the sensors comprises information indicating that a configuration file has been modified.

20. The method of claim 11, wherein the first server and second server are located in the cloud.
